(19) United States
(12) Patent Application Publication
(10) Pub. No.: US 2025/0267656 A1
(43) Pub. Date: Aug. 21, 2025

(54) METHODS AND APPARATUS FOR PRIORITIZING DATA FOR TRANSMISSION

(71) Applicant: Huawei Technologies Co., Ltd., Shenzhen (CN)

(72) Inventor: Yunsong Yang, San Diego, CA (US)

(21) Appl. No.: 19/197,649

(22) Filed: May 2, 2025

Related U.S. Application Data
(63) Continuation of application No. PCT/US2023/078540, filed on Nov. 2, 2023.
(60) Provisional application No. 63/422,191, filed on Nov. 3, 2022.

(51) Int. Cl. H04W 72/1268; H04W 72/0453; H04W 72/51; H04W 72/543; H04W 72/566

(52) U.S. Cl. CPC H04W 72/1268; H04W 72/0453; H04W 72/51; H04W 72/543; H04W 72/566

(57) ABSTRACT

A system, apparatus, and method for prioritizing data for transmission is provided. In accordance with an embodiment, a method implemented by a user equipment (UE) includes receiving data bursts at one or more logical channels of the UE for transmission to a radio access network (RAN) node serving the UE, wherein the different data bursts have different deadlines for delivery. The method also includes receiving scheduling information about an uplink resource for the UE to transmit to the RAN node. The method also includes determining the transmission priorities for the data bursts based on the information associated with the transmission priorities. The method also includes transmitting, to the RAN node, the uplink data from at least one of at least a portion of a first data burst and at least a portion of a second data burst in accordance with the scheduling information and the transmission priorities.

### PRIORITY CLAIM AND CROSS-REFERENCE

This patent application is a continuation of PCT Application No. PCT/US2023/078540, filed on Nov. 2, 2023 and entitled “Methods and Apparatus for Prioritizing Data for Transmission,” which claims the benefit of U.S. Provisional Application No. 63/422,191, filed on Nov. 3, 2022 and entitled “Methods and Apparatus for Prioritizing Data for Transmission,” applications of which are hereby incorporated by reference herein as if reproduced in their entireties.

### TECHNICAL FIELD

The present disclosure relates generally to methods and apparatus for wireless communications, and, in particular embodiments, to methods and apparatus for prioritizing data for transmission.

### BACKGROUND

In a wireless communication system compliant with the fifth generation (5G) new radio (NR) standards, data transmissions over the uplink (UL), i.e., from a user equipment (UE) to a radio access network (RAN) node serving the UE are scheduled by the RAN node. A typical example of an RAN node is referred to as the next generation Node B (gNB). The RAN node indicates to the UE, in advance, UL radio resource allocated for the UE to transmit. However, the UE may have more than one quality of service (QoS) flows of a same service (e.g., video and audio of a video telephony service) or of different services (e.g., audio and web browsing) running on the UE simultaneously. Currently, upon arriving at a starting time of a UL resource being granted with, the UE selects data available at competing logical channels (LCHs), configured for the different QoS flows of the UE, using LCH prioritization (LCP) procedure, which is based on the priorities of the LCHs and available tokens virtually built up for the LCHs. The virtual tokens are built up for each LCH in time at a pre-configured rate typically set based on an average data rate estimated for the LCH. Based on the priorities and available tokens of the competing LCHs, a Media Access Control (MAC) scheduler of the UE first selects data from a first LCH with the highest priority until one of the following events occurs: 1) the granted resource is exhausted; 2) buffer of the first LCH becomes empty (e.g., all buffered data for the first LCH have been selected); and 3) the available tokens for the first LCH are depleted. In the latter two cases, if the granted resources aren't exhausted yet, the scheduler starts to select data from a second LCH in a descending order of priority, until one of the aforementioned three events occurs for the second LCH. And so on and so forth. An XR service typically produces multiple periodic and delay-sensitive data streams with different periodicities, the delay budget for each data stream being typically longer than the respective traffic periodicity. Hence, data buffered at an LCH for an XR data stream may consist of multiple packets or multiple data bursts generated at different points in time and hence having different remaining time until the respective delivery deadline. While packets of XR audio and pose streams tend to have a constant packet size, XR video usually has a variable frame size and hence variable PDU Set size.

### SUMMARY

Technical advantages are generally achieved, by embodiments of this disclosure which describe systems, apparatuses, and methods for prioritizing data transmission.

In accordance with an embodiment, a method implemented by a user equipment (UE) includes receiving a first data burst and a second data burst at one or more logical channels of the UE for transmission to a radio access network (RAN) node serving the UE, wherein the first data burst and the second data burst have different deadlines for delivery. The method also includes obtaining information associated with transmission priorities for the first data burst and the second data burst. The method also includes storing the first data burst and the second data burst in a buffer with or in accordance with the information associated with the transmission priorities for the first data burst and the second data burst. The method also includes receiving, from the RAN node, scheduling information about an uplink resource scheduled by the RAN node for the UE to transmit to the RAN node. The method also includes determining the transmission priorities between the first data burst and the second data burst based on the information associated with the transmission priorities. The method also includes transmitting, to the RAN node, the uplink data from at least one of at least a portion of the first data burst and at least a portion of the second data burst in accordance with the scheduling information and the transmission priorities.

In accordance with an embodiment, a method implemented by a radio access network (RAN) node, the method includes sending configuration information to a user equipment (UE) to configure the UE to buffer different data bursts arrived at one or more logical channels of the UE for transmission, the UE being served by the RAN node. The method also includes providing the UE with information used for determining transmission priorities among the different data bursts. The method also includes transmitting, to the UE, scheduling information about an uplink resource scheduled for the UE to transmit to the RAN node. The method also includes receiving, from the UE, the different data bursts in accordance with the uplink resource.

In an embodiment, the information associated with transmission priorities includes at least one of a remaining time until a respective delivery deadline for each of the first data burst and the second data burst, priorities assigned to each of a plurality of sub-buffers used for storing the first data burst and the second data burst, priorities assigned to labels associated with the first data burst and the second data burst that indicate a sequences of respective deadlines for delivery associated with the each of the first data burst and the second data burst, a respective dwelling time of the each of the first data burst and the second data burst at the UE, an indication of or a lack of the indication of end Protocol Data Unit (PDU) of a PDU set associated with a respective one of the first data burst and the second data burst, an indication of or a lack of the indication of end of data burst associated with a respective one of the first data burst and the second data burst, a PDU set integrity handling information associated with a respective one of the first data burst and the second data burst, and a PDU set importance associated with a respective one of the first data burst and the second data burst.

In an embodiment, the method also includes receiving information about the delay budget from a session management function (SMF) serving the UE.

In an embodiment, the information associated with the transmission priorities comprises information about priorities assigned to different sub-buffers of the buffer currently buffering the first data burst and the second data burst, respectively, and wherein the obtaining the information associated with the transmission priorities includes receiving, by the UE from the RAN node, the information about priorities assigned by the RAN node to the different sub-buffers; and identifying, by the UE, sub-buffers currently buffering the first data burst and the second data burst, respectively.

In an embodiment, the method also includes determining that one traffic period has ended, and based thereon, transferring each of the first data burst and the second data burst from a current sub-buffer of the buffer to a next sub-buffer of the buffer, the next sub-buffer being located immediately below the current sub-buffer and being logically connected to the current sub-buffer, the buffer including a plurality of cascaded sub-buffers.

In an embodiment, the information associated with the transmission priorities includes information about priorities assigned by the RAN node to different values for burst identifier (ID) and burst ID values currently being associated with the different data bursts, respectively, and wherein the obtaining the information associated with the transmission priorities includes receiving, by the UE from the RAN node, the information about the transmission priorities assigned by the RAN node to the different values for burst ID, and identifying, by the UE, the burst ID values currently being associated with the first data burst and the second data burst, respectively.

In an embodiment, the method also includes associating each of the first data burst and the second data burst with a respective burst ID at a time when the each of the first data burst and the second data burst arrived at the one or more logical channels of the UE, a value of the respective burst ID being initially set to a specific value configured by the RAN node for the one or more logical channels; and at every time instance when a new traffic period has elapsed, decrementing the burst ID values currently being associated with the different data bursts by one.

In an embodiment, the method also includes transmitting, by the UE, an indication of the UE capabilities of prioritizing uplink data to the RAN node; and receiving, at the UE, configuration information from the RAN node, wherein the configuration information provides information for the UE to perform prioritization of the first data burst and the second data burst.

In an embodiment, the information associated with the transmission priorities comprises information about respective delivery deadlines of the first data burst and the second data burst, and wherein the obtaining the information associated with the transmission priorities includes determining, by the UE, arrival points in time of the first data burst and the second data burst when the first data burst and the second data burst respectively arrived at the one or more logical channels of the UE for transmission; and determining, by the UE, the respective delivery deadlines of the first data burst and the second data burst as being equal to a sum of a delay budget and respective arrival points in time of the first data burst and the second data burst.

In accordance with an embodiment, a user equipment (UE) includes a non-transitory memory storage storing instructions; and one or more processors in communication with the non-transitory memory storage, the one or more processors executing the instructions to cause the UE to perform several procedures. The procedures include receiving a first data burst and a second data burst at one or more logical channels of the UE for transmission to a radio access network (RAN) node serving the UE, wherein the first data burst and the second data burst have different deadlines for delivery. The procedures also include obtaining information associated with transmission priorities for the first data burst and the second data burst. The procedures also include storing the first data burst and the second data burst in a buffer with or in accordance with the information associated with the transmission priorities for the first data burst and the second data burst. The procedures also include receiving, from the RAN node, scheduling information about an uplink resource scheduled by the RAN node for the UE to transmit to the RAN node. The procedures also include determining the transmission priorities between the first data burst and the second data burst based on the information associated with the transmission priorities. The procedures also include transmitting, to the RAN node, the uplink data from at least one of at least a portion of the first data burst and at least a portion of the second data burst in accordance with the scheduling information and the transmission priorities.

In accordance with an embodiment, a method implemented by a radio access network (RAN) node, the method includes sending configuration information to a user equipment (UE) to configure the UE to buffer different data bursts arrived at one or more logical channels of the UE for transmission, the UE being served by the RAN node. The method also includes providing the UE with information used for determining transmission priorities among the different data bursts. The method also includes transmitting, to the UE, scheduling information about an uplink resource scheduled for the UE to transmit to the RAN node. The method also includes receiving, from the UE, the different data bursts in accordance with the uplink resource.

In an embodiment, the method also includes receiving a report from the UE, the report including information about the different data bursts being buffered at the UE for transmission to the RAN node; and scheduling the uplink resource for the UE to transmit to the RAN node based on the report received.

In an embodiment, the information used for determining transmission priorities among the different data bursts includes at least one of a remaining time until a respective delivery deadline for each of the different data bursts, priorities assigned to each of a plurality of sub-buffers used for storing the different data bursts, priorities assigned to labels associated with the different data bursts that indicate a sequences of respective deadlines for delivery associated with the each of the different data bursts, a respective dwelling time of each of the different data bursts at the UE, an indication of or a lack of the indication of end Protocol Data Unit (PDU) of a PDU set associated with a respective one of the different data bursts, an indication of or a lack of the indication of end of data burst associated with a respective one of the different data bursts, a PDU set integrity handling information associated with a respective one of the different data bursts, and a PDU set importance associated with a respective one of the different data bursts.

In an embodiment, the configuration information including information of a specific number of cascaded sub-buffers to be configured in a buffer of the UE and to be used by the UE for buffering the different data bursts, respectively.

In an embodiment, the information provided to the UE for determining the transmission priorities among the different data bursts includes information about the transmission priorities respectively assigned by the RAN node to the specific number of cascaded sub-buffers.

In an embodiment, the configuration information includes information of a specific number used for initializing a value of a burst identifier (ID) that is associated with each of the different data bursts at a time when the each of the different data bursts arrived at the logical channel of the UE for transmission.

In an embodiment, the information provided to the UE for determining the transmission priorities among the different data bursts includes information about the transmission priorities respectively assigned by the RAN node to a specific number of different values for the burst ID.

In an embodiment, the method also includes receiving information about quality of service (QoS) requirements of a service of the UE, the different data bursts being generated for the service, the specific number being determined based on the information about the QoS requirements.

In an embodiment, the method also includes receiving information from the UE indicating the UE's capabilities of prioritizing uplink data; determining the configuration information to be sent to the UE according to the UE's capabilities of prioritizing uplink data; and transmitting the configuration information to the UE.

In accordance with an embodiment, a radio access network (RAN) node includes a non-transitory memory storage storing instructions; and one or more processors in communication with the non-transitory memory storage, the one or more processors executing the instructions to cause the RAN node to perform several procedures. The procedures include sending configuration information to a user equipment (UE) to configure the UE to buffer different data bursts arrived at one or more logical channels of the UE for transmission, the UE being served by the RAN node. The procedures also include providing the UE with information used for determining transmission priorities among the different data bursts. The procedures also include transmitting, to the UE, scheduling information about an uplink resource scheduled for the UE to transmit to the RAN node. The procedures also include receiving, from the UE, the different data bursts in accordance with the uplink resource.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates an example transmission buffer consisting of N cascaded leaky buckets in accordance with an embodiment;

FIG. 2 illustrates two example transmission buffers configured for a UE in accordance with an embodiment;

FIG. 3 illustrates an example of using Burst IDs currently being labelled (associated) with different data bursts buffered in a buffer to determine transmission priorities among the different data bursts in accordance with an embodiment;

FIG. 4 is an example of two buffers configured in a UE for storing data in accordance with an embodiment;

FIG. 5 illustrates a flow diagram of example embodiment of operations occurring in a UE, in accordance with an embodiment;

FIG. 6 illustrates a flow diagram of example embodiment of operations occurring in a RAN node, such as a gNB, in accordance with an embodiment;

FIG. 7 illustrates an example communication system 700 in accordance with an embodiment;

FIGS. 8A and 8B illustrate example devices that may implement the methods and teachings according to this disclosure;

FIG. 9 is a block diagram of a computing system 900 that may be used for implementing the devices and methods disclosed herein; and

FIG. 10 illustrates an example communications system.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Disclosed herein are systems, apparatuses, and methods for prioritizing data for transmission. In accordance with an embodiment, a method implemented by a UE includes receiving a first data burst and a second data burst at one or more logical channels of the UE for transmission to an RAN node serving the UE, wherein the first data burst and the second data burst have different deadlines for delivery. The method also includes obtaining information associated with transmission priorities for the first data burst and the second data burst. The method also includes storing the first data burst and the second data burst in a buffer with or in accordance with the information associated with the transmission priorities for the first data burst and the second data burst. The method also includes receiving, from the RAN node, scheduling information about an uplink resource scheduled by the RAN node for the UE to transmit to the RAN node. The method also includes determining the transmission priorities between the first data burst and the second data burst based on the information associated with the transmission priorities. The method also includes transmitting, to the RAN node, the uplink data from at least one of at least a portion of the first data burst and at least a portion of the second data burst in accordance with the scheduling information and the transmission priorities.

In accordance with an embodiment, a method implemented by a radio access network (RAN) node, the method includes sending configuration information to a user equipment (UE) to configure the UE to buffer different data bursts arrived at one or more logical channels of the UE for transmission, the UE being served by the RAN node. The method also includes providing the UE with information used for determining transmission priorities among the different data bursts. The method also includes transmitting, to the UE, scheduling information about an uplink resource scheduled for the UE to transmit to the RAN node. The method also includes receiving, from the UE, the different data bursts in accordance with the uplink resource.

In an embodiment, the information associated with transmission priorities includes at least one of a remaining time until a respective delivery deadline for each of the first data burst and the second data burst, priorities assigned to each of a plurality of sub-buffers used for storing the first data burst and the second data burst, priorities assigned to labels associated with the first data burst and the second data burst that indicate a sequences of respective deadlines for delivery associated with the each of the first data burst and the second data burst, a respective dwelling time of the each of the first data burst and the second data burst at the UE, an indication of or a lack of the indication of end Protocol Data Unit (PDU) of a PDU set associated with a respective one of the first data burst and the second data burst, an indication of or a lack of the indication of end of data burst associated with a respective one of the first data burst and the second data burst, a PDU set integrity handling information associated with a respective one of the first data burst and the second data burst, and a PDU set importance associated with a respective one of the first data burst and the second data burst.

In an embodiment, the method also includes receiving information about the delay budget from a session management function (SMF) serving the UE.

In an embodiment, the information associated with the transmission priorities comprises information about priorities assigned to different sub-buffers of the buffer currently buffering the first data burst and the second data burst, respectively, and wherein the obtaining the information associated with the transmission priorities includes receiving, by the UE from the RAN node, the information about priorities assigned by the RAN node to the different sub-buffers; and identifying, by the UE, sub-buffers currently buffering the first data burst and the second data burst, respectively.

In an embodiment, the method also includes determining that one traffic period has ended, and based thereon, transferring each of the first data burst and the second data burst from a current sub-buffer of the buffer to a next sub-buffer of the buffer, the next sub-buffer being located immediately below the current sub-buffer and being logically connected to the current sub-buffer, the buffer including a plurality of cascaded sub-buffers.

In an embodiment, the information associated with the transmission priorities includes information about priorities assigned by the RAN node to different values for burst identifier (ID) and burst ID values currently being associated with the different data bursts, respectively, and wherein the obtaining the information associated with the transmission priorities includes receiving, by the UE from the RAN node, the information about the transmission priorities assigned by the RAN node to the different values for burst ID, and identifying, by the UE, the burst ID values currently being associated with the first data burst and the second data burst, respectively.

In an embodiment, the method also includes associating each of the first data burst and the second data burst with a respective burst ID at a time when the each of the first data burst and the second data burst arrived at the one or more logical channels of the UE, a value of the respective burst ID being initially set to a specific value configured by the RAN node for the one or more logical channels; and at every time instance when a new traffic period has elapsed, decrementing the burst ID values currently being associated with the different data bursts by one.

In an embodiment, the method also includes transmitting, by the UE, an indication of the UE capabilities of prioritizing uplink data to the RAN node; and receiving, at the UE, configuration information from the RAN node, wherein the configuration information provides information for the UE to perform prioritization of the first data burst and the second data burst.

In an embodiment, the information associated with the transmission priorities comprises information about respective delivery deadlines of the first data burst and the second data burst, and wherein the obtaining the information associated with the transmission priorities includes determining, by the UE, arrival points in time of the first data burst and the second data burst when the first data burst and the second data burst respectively arrived at the one or more logical channels of the UE for transmission; and determining, by the UE, the respective delivery deadlines of the first data burst and the second data burst as being equal to a sum of a delay budget and respective arrival points in time of the first data burst and the second data burst.

In accordance with an embodiment, a user equipment (UE) includes a non-transitory memory storage storing instructions; and one or more processors in communication with the non-transitory memory storage, the one or more processors executing the instructions to cause the UE to perform several procedures. The procedures include receiving a first data burst and a second data burst at one or more logical channels of the UE for transmission to a radio access network (RAN) node serving the UE, wherein the first data burst and the second data burst have different deadlines for delivery. The procedures also include obtaining information associated with transmission priorities for the first data burst and the second data burst. The procedures also include storing the first data burst and the second data burst in a buffer with or in accordance with the information associated with the transmission priorities for the first data burst and the second data burst. The procedures also include receiving, from the RAN node, scheduling information about an uplink resource scheduled by the RAN node for the UE to transmit to the RAN node. The procedures also include determining the transmission priorities between the first data burst and the second data burst based on the information associated with the transmission priorities. The procedures also include transmitting, to the RAN node, the uplink data from at least one of at least a portion of the first data burst and at least a portion of the second data burst in accordance with the scheduling information and the transmission priorities.

In accordance with an embodiment, a method implemented by a radio access network (RAN) node, the method includes sending configuration information to a user equipment (UE) to configure the UE to buffer different data bursts arrived at one or more logical channels of the UE for transmission, the UE being served by the RAN node. The method also includes providing the UE with information used for determining transmission priorities among the different data bursts. The method also includes transmitting, to the UE, scheduling information about an uplink resource scheduled for the UE to transmit to the RAN node. The method also includes receiving, from the UE, the different data bursts in accordance with the uplink resource.

In an embodiment, the method also includes receiving a report from the UE, the report including information about the different data bursts being buffered at the UE for transmission to the RAN node; and scheduling the uplink resource for the UE to transmit to the RAN node based on the report received.

In an embodiment, the information used for determining transmission priorities among the different data bursts includes at least one of a remaining time until a respective delivery deadline for each of the different data bursts, priorities assigned to each of a plurality of sub-buffers used for storing the different data bursts, priorities assigned to labels associated with the different data bursts that indicate a sequences of respective deadlines for delivery associated with the each of the different data bursts, a respective dwelling time of each of the different data bursts at the UE, an indication of or a lack of the indication of end Protocol Data Unit (PDU) of a PDU set associated with a respective one of the different data bursts, an indication of or a lack of the indication of end of data burst associated with a respective one of the different data bursts, a PDU set integrity handling information associated with a respective one of the different data bursts, and a PDU set importance associated with a respective one of the different data bursts.

In an embodiment, the configuration information including information of a specific number of cascaded sub-buffers to be configured in a buffer of the UE and to be used by the UE for buffering the different data bursts, respectively.

In an embodiment, the information provided to the UE for determining the transmission priorities among the different data bursts includes information about the transmission priorities respectively assigned by the RAN node to the specific number of cascaded sub-buffers.

In an embodiment, the configuration information includes information of a specific number used for initializing a value of a burst identifier (ID) that is associated with each of the different data bursts at a time when the each of the different data bursts arrived at the logical channel of the UE for transmission.

In an embodiment, the information provided to the UE for determining the transmission priorities among the different data bursts includes information about the transmission priorities respectively assigned by the RAN node to a specific number of different values for the burst ID.

In an embodiment, the method also includes receiving information about quality of service (QoS) requirements of a service of the UE, the different data bursts being generated for the service, the specific number being determined based on the information about the QoS requirements.

In an embodiment, the method also includes receiving information from the UE indicating the UE's capabilities of prioritizing uplink data; determining the configuration information to be sent to the UE according to the UE's capabilities of prioritizing uplink data; and transmitting the configuration information to the UE.

In accordance with an embodiment, a radio access network (RAN) node includes a non-transitory memory storage storing instructions; and one or more processors in communication with the non-transitory memory storage, the one or more processors executing the instructions to cause the RAN node to perform several procedures. The procedures include sending configuration information to a user equipment (UE) to configure the UE to buffer different data bursts arrived at one or more logical channels of the UE for transmission, the UE being served by the RAN node. The procedures also include providing the UE with information used for determining transmission priorities among the different data bursts. The procedures also include transmitting, to the UE, scheduling information about an uplink resource scheduled for the UE to transmit to the RAN node. The procedures also include receiving, from the UE, the different data bursts in accordance with the uplink resource.

In 5G NR, one or more data radio bearers (DRBs) and more than one logical channels (LCHs) may be configured for a UE to communicate with a gNB (as an example RAN node used in the various embodiments described herein and hereafter) serving the UE, depending on the number of quality of service (QoS) flows of the service(s) being supported. Each LCH is associated with either a signaling radio bearer (SRB) or one of the one or more DRBs configured. Transmissions over the downlink (DL), i.e., from the gNB to the UEs, are scheduled and controlled by the gNB. On the other hand, the radio resources used for transmissions over the uplink (UL), i.e., from the UEs to the gNB, are scheduled by the gNB, based on a variety of information. However, the UE that is granted by the gNB with the scheduled radio resources has an uplink rate control function, which manages the sharing of uplink resources between the LCHs for which the UE has UL data available for transmission.

Radio resource control (RRC) layer controls the scheduling of UL data by signaling for each LCH: 1) priority where an increasing priority value indicates a lower priority level, 2) prioritisedBitRate which sets the Prioritized Bit Rate (PBR), and 3) bucketSizeDuration which sets the Bucket Size Duration (BSD) [1].

The UE shall maintain a variable Bj for each LCH j. Bj shall be initialized to zero when LCH j is established, and incremented by the product PBR×T, where T is the time elapsed since Bj was last incremented, where PBR is the Prioritized Bit Rate of LCH j. However, the value of Bj can never exceed the bucket size and if the value of Bj is larger than the bucket size of LCH j, it shall be set to the bucket size. The bucket size of an LCH is equal to PBR×BSD, where PBR and BSD are configured by upper layers [2].

The Logical Channel Prioritization (LCP) procedure is applied when a new transmission over a granted UL resource is performed. One simple way to meet this purpose is to serve LCHs having data competing for the granted UL resource in order of their priority. Following this principle, the data from the LCH of the highest priority is the first to be included into the MAC PDU, followed by data from the LCH of the next highest priority, continuing until the MAC PDU size allocated by the gNB is completely filled or there is no more data to transmit.

Although this kind of priority-based multiplexing is simple and favors the highest priorities, it sometimes leads to starvation of low-priority bearers. Starvation occurs when the LCHs of the lower priority cannot transmit any data because the data from higher priority LCHs always takes up all the allocated radio resources. To avoid starvation, while still serving the LCHs according to their priorities, a Prioritized Bit Rate (PBR) is configured by the gNB for each LCH of the UE. The PBR is the data rate provided to one LCH before allocating any resource to a lower-priority LCH.

In order to take into account both the PBR and the priority, each LCH is served in decreasing order of priority, but the amount of data from each LCH included into the MAC PDU is initially limited to the amount corresponding to the configured PBR. Only when all LCHs have been served up to their PBR, then if there is still room left in the MAC PDU, each LCH is served again in decreasing order of priority. In this second round, each LCH is served only if all LCHs of higher priority have no more data for transmission.

XR applications are expected to be an important driving force for developing the next generation wireless communication technologies, due to their demands for support of high data throughputs, high system capacity, high reliability, and low latency simultaneously. In XR applications, the UL data traffic usually consists of an audio stream, a sensing or pose data stream, and for augmented reality (AR), a video stream, each stream consisting of periodic bursts of data with different periodicities and different delay requirements. For example, an audio packet may be generated every 10 milliseconds (msec) and has a delay budget of about 30 msec for the audio stream, a pose packet may be generated every 2.5 milliseconds (msec) and has a delay budget of about 10 msec for the pose stream, and for the UL video stream, a data burst consisting of one or more packets corresponding to a video frame may be generated periodically, e.g., every 16.666 milliseconds (msec) for a frame refresh rate of 60 frames per second (FPS), and has a delay budget of about 30 msec. For the sensing/pose data stream and the UL video stream, each packet should be transmitted from the UE to the gNB within the respective delay budget; otherwise, the packet may become unusable to the application layer (such as a graphics/rendering engine or a video decoder) on a destination (such as an XR application server in the cloud or edge cloud), or at least the user experience may suffer, e.g., the user may experience cyber-sickness, such as feeling dizzy, disoriented, and nauseous.

In addition, for the video stream, the total data volume of a burst of data packets that correspond to a same video frame changes from time to time, depending on the graphic content of the video frame as well as depending on whether the video frame is an intra-coded frame (I-frame) or a predicted frame (P-frame). A burst of data packets corresponding to a same video frame are also collectively referred as a protocol data unit (PDU) set. Every PDU of a same PDU set may be needed by the decoder in order to decode and decompress the video frame. Hence, the existing LCP mechanism, which is based on a mix of prioritization (at the LCH level) and token bucket scheduler, as described before, may no longer be suitable for handling the prioritization among data packets of one or more XR traffic streams and/or between data packets of an XR traffic stream and a non-XR traffic stream.

For the various UL XR traffic streams, as described above, the packet delay budget (PDB) is usually longer than the corresponding traffic periodicity (the time interval between consecutive packets or between consecutive bursts of packets), which means at a given time, data in the transmission buffer of an LCH associated with an XR traffic may consist of multiple bursts of packets (or data bursts), which are generated at different points in time and hence have different amount of time remaining before the respective delivery deadlines. For example, some packets that arrived at an LCH for transmission during an earlier traffic cycle (and hence their delivery deadline may be fast approaching) may have an urgent need to be transmitted no matter how bad is the current channel condition or interference condition on the UL, while some other packets that just arrived at the same LCH may have a longer remaining time before their delivery deadline (and hence the gNB has more time to wait for a more favorable channel condition or interference condition to schedule the transmission of them).

The current LCP mechanism considers priorities only at the LCH level. It essentially treats all packets of a same LCH as having the same priority for transmission, without the ability to differentiate, for a periodical traffic such as an XR video traffic, that one burst of data packets that arrives at the LCH from the upper layers during an earlier traffic cycle may need to be transmitted more urgently than another burst of data packets that arrives at the same LCH during a later traffic cycle. The current LCP mechanism does not have the ability to prioritize a packet or a burst of packets of a lower-priority LCH with a short remaining time for delivery over another packet or another burst of packets of a higher-priority LCH with a much longer remaining time for delivery.

Currently, the LCP procedure is performed in such a way that competing LCHs are served sequentially in priority order and for each, up to an amount of bits represented by the number of tokens in the bucket (referred to as Bj, as previously described), thus enforcing a PBR for each LCH. However, the pre-specified PBR value is not adaptive to the variable size of data bursts of a UL XR video stream. Based on the fixed PBR value, a PDU set corresponding to a video frame may be unnecessarily cut into segments and be separately transmitted when the granted UL resource is actually sufficient to transmit the entire PDU set. In this example, the available tokens in the bucket are insufficient for the entire PDU set, potentially causing some piece(s) of the PDU set to miss the final delivery deadline for the entire PDU set to be decoded and displayed in time at the application level.

A first objective that may be applicable to one or more embodiments is to provide means for a UE to buffer different data bursts arriving at one or more LCHs of the UE for a transmission to a gNB, the different data bursts being buffered in a manner such that information associated with transmission priorities among the different data bursts is known to the UE; to receive scheduling information about uplink resource scheduled by the gNB for the UE to transmit; to determine the transmission priorities among the different data bursts in accordance with the information associated with the transmission priorities among the different data bursts that is known to the UE; and to transmit the different data bursts to the gNB in accordance with the scheduling information received and the transmission priorities determined.

A second objective that may be applicable to one or more embodiments is to provide means for a gNB to configure a UE with information used by the UE for buffering data bursts arriving at one or more LCHs of the UE, information used for determining the transmission priorities among the different data bursts, and information used by the UE for transmitting the different data bursts.

Methods for a UE buffering data bursts arrived from upper layers for transmission, determining transmission priorities among the data bursts, and transmitting the data bursts in accordance with the transmission priorities determined are described below.

A method is provided for a gNB to configure a UE to buffer different data bursts arriving from upper layers at one or more LCHs of the UE for transmission; the different data bursts being buffered in a manner such that information associated with transmission priorities among the different data bursts is known to the UE. The method also enables the gNB to provide the UE with information used for determining the transmission priorities among the different data bursts. The method also enables the gNB to provide the UE with information about uplink resources scheduled by the gNB for the UE to transmit the different data bursts.

A method is also provided for the UE, based on configuration information received from the gNB, to buffer different data bursts arriving from upper layers at the one or more LCHs of the UE for transmission, the different data bursts being buffered in a manner such that information associated with transmission priorities among the different data bursts is known to the UE. In some embodiments, the information associated with the transmission priorities comprises information about remaining time durations until the respective delivery deadlines of the different data bursts. In some other embodiments, the information associated with the transmission priorities comprises information about the priorities assigned to different sub-buffers (also referred to as leaky buckets) currently buffering the different data bursts, respectively, wherein the information about the priorities assigned to the different sub-buffers have been received from the gNB. In yet some other embodiments, the information associated with the transmission priorities comprises information about the priorities assigned to different burst IDs currently being associated with the different data bursts, respectively, wherein the information about the priorities assigned to the different burst IDs have been received from the gNB. The method also enables the UE, based on the information associated with the transmission priorities, to determine the transmission priorities among the different data bursts. The method further enables the UE to receive scheduling information about uplink resource scheduled by the gNB for the UE to transmit to the gNB. The method further enables the UE to transmit the different data bursts in accordance with the transmission priorities among the different data bursts determined and the scheduling information received. The UE is further configured to discard any remaining packets of a data burst of which the remaining time duration until the delivery deadline has reached zero (i.e., the delivery deadline has passed).

Embodiment 1: using cascaded leaky buckets for buffering data bursts arrived from upper layers for transmission and for determining transmission priorities among the data bursts being buffered.

In some embodiments, the UE is configured to store data bursts that periodically arrive at an LCH of the UE in a transmission buffer that consists of N cascaded leaky buckets (which may also be referred to as sub-buffers, storage bins, etc.), where N is an integer greater than or equal to a delay budget (e.g., PDB or PSDB) of a QoS flow associated with the LCH divided by the traffic periodicity of the QoS flow.

For example, the number N may be determined by the gNB and informed to the UE via an RRC signaling sent from the gNB to the UE. For example, for a UL video stream of an AR application, if the video refresh rate is 60 FPS and the PDB or PSDB is 30 msec, N is determined to be equal to ceiling(30/16.6666) and hence equal to 2, where ceiling( ) is the ceiling function.

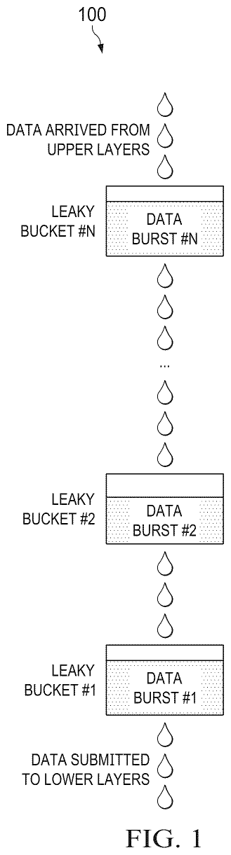

FIG. 1 illustrates an example transmission buffer 100 consisting of N cascaded leaky buckets in accordance with an embodiment. Among the N cascaded leaky buckets, a first leaky bucket (such as Leaky bucket #1 in FIG. 1) at the bottom (the egress point) of the transmission buffer 100 (i.e., being closest to the MAC sublayer) is used for storing data burst of which the delivery deadline is within one traffic period, a second leaky bucket (such as Leaky bucket #2 in FIG. 1) immediately above and logically connected to the first leaky bucket is used for storing data burst of which the delivery deadline is between one and two traffic periods away, a third leaky bucket immediately above and connected to the second leaky bucket is used for storing data burst of which the delivery deadline is between two and three traffic periods away, and so on and so forth. When the delivery deadline for the data burst in the first leaky bucket is reached, any data remaining in the first leaky bucket, whose transmission has not started yet or has not been completed yet, may be discarded. Then, any data stored in the second leaky bucket are dumped (e.g., transferred and stored) into the first leaky bucket in a first-in first-out (FIFO) order, and then, any data stored in the third leaky bucket are dumped into the second leaky bucket in the FIFO order, and so on and so forth. And, as a result, the N^{th} leaky bucket (such as Leaky bucket #N in FIG. 1) at the top (the ingress point) of the transmission buffer 100 may be emptied for a new burst of data to arrive within the next traffic cycle.

In some embodiments, all of the N cascaded leaky buckets are located within a transmitting (UM) RLC entity or the transmitting side of an (AM) RLC entity configured to serve the LCH. In some other embodiments, some of the N cascaded leaky buckets (such as Leaky bucket #N in FIG. 1) are located within the transmitting PDCP entity associated with the LCH, while the rest of the N cascaded leaky buckets are located within the transmitting (UM) RLC entity or the transmitting side of the (AM) RLC entity associated with the LCH.

In some embodiments, when the UE has multiple QoS flows that can produce periodic and delay-sensitive data bursts, the UE can be configured with more than one sets of cascaded leaky buckets to store data bursts that are from different QoS flows and periodically arrive at different LCHs of the UE, wherein the different sets of cascaded leaky buckets may consist of different numbers of cascaded leaky buckets, based on the delay budget of the QoS flow associated with the respective LCH divided by the traffic periodicity of the QoS flow.

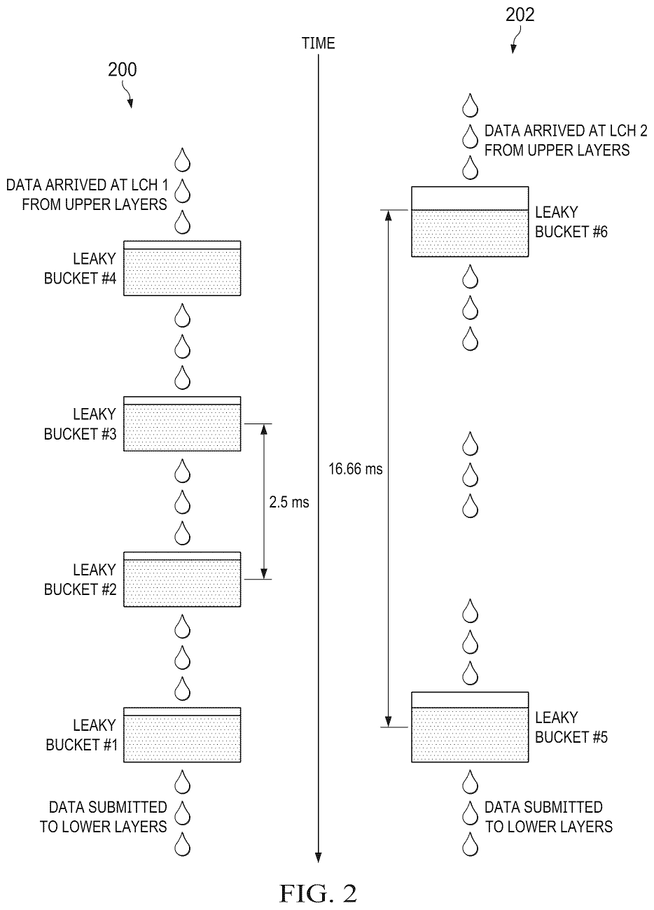

FIG. 2 illustrates two example transmission buffers 200, 202 configured for a UE in accordance with an embodiment. One transmission buffer 200 includes 4 cascaded leaky buckets and serves a first LCH (denoted as LCH 1 in FIG. 2) configured for a pose/control stream, and the other transmission buffer 202 includes 2 cascaded leaky buckets and serves a second LCH (denoted as LCH 2 in FIG. 2) configured for a video stream.

As shown in FIG. 2, the gNB determines that 4 cascaded leaky buckets are needed for LCH 1 because a pose packet from the pose stream arrives at LCH 1 every 2.5 msec and the PDB for the pose packets is 10 msec, and the gNB determines that 2 cascaded leaky buckets are needed for LCH 2 because a burst of packets corresponding to a video frame from the video stream arrives at LCH 2 every 16.66 msec (for a frame refresh rate of 60 FPS) and the PSDB for video PDU sets is 30 msec. And the gNB sends configuration information to the UE causing the UE to configure 4 cascaded leaky buckets for LCH 1 and 2 cascaded leaky buckets for LCH 2. The gNB may further assign a Bucket ID for each of the six leaky buckets. The Bucket IDs assigned may be unique only within LCH 1 and within LCH 2 but not necessarily between LCH 1 and LCH 2. Alternatively, the Bucket IDs assigned, e.g., denoted as #1 to #6 in FIG. 2, may be unique among all six leaky buckets. The gNB may further designate a first priority level indicating a highest priority level for data burst stored in Leaky bucket #1, a second priority level indicating a second highest priority level for data burst stored in Leaky bucket #2, a third priority level indicating a third highest priority level for data burst stored in Leaky bucket #3, and a fourth priority level indicating a fourth highest priority level for data burst stored in Leaky bucket #4, because remaining time until a delivery deadline of the data burst stored in Leaky buckets #1-4 is between 0 and 2.5 msec for Leaky bucket #1, between 2.5 msec and 5 msec for Leaky bucket #2, between 5 msec and 7.5 msec for Leaky bucket #3, and between 7.5 msec and 10 msec for Leaky bucket #4.

The gNB may further designate a fifth priority level that is between the first priority level and the fourth priority level for data burst stored in Leaky bucket #5, because remaining time until a delivery deadline of the data burst stored in Leaky bucket #5 is between 0 and 16.66 msec. The gNB may further designate a sixth priority level that is lower than any of the first to the fifth priority levels for data burst stored in Leaky bucket #6, because remaining time until a delivery deadline of the data burst stored in Leaky bucket #6 is the longest. The gNB may further configure the UE with information about the priority levels designated to the leaky buckets, respectively.

The UE may use remaining time that the UE keeps tracking for delivering the associated data bursts to determine the transmission priorities of these data bursts. Alternatively, the UE may simply use the priority levels that the gNB has designated for each leaky bucket to determine the transmission priorities of the data bursts currently stored in the respective leaky buckets.

Embodiment 2: using regular buffer for buffering data bursts arrived from upper layers for transmission and using data burst labels for determining the transmission priorities among the data bursts being buffered.

In yet some other embodiments, without physically using N cascaded leaky buckets, a burst of data arrived at an LCH may simply be labeled with a Burst ID equal to the number N and be stored in a conventional transmission buffer configured for the LCH in the FIFO manner, where N is the integer greater than or equal to the delay budget (e.g., PDB or PSDB) of the QoS flow associated with the LCH divided by the traffic periodicity of the QoS flow, as described before. Then, for each passing traffic period, all the Burst IDs labeled with the stored data bursts are decremented by 1 (equivalent to dumping or moving every data burst from a bucket to another bucket immediately below). Data burst labelled (or associated) with Burst ID value 1 (one) has the shortest remaining time (at least with a same LCH) until its delivery deadline.

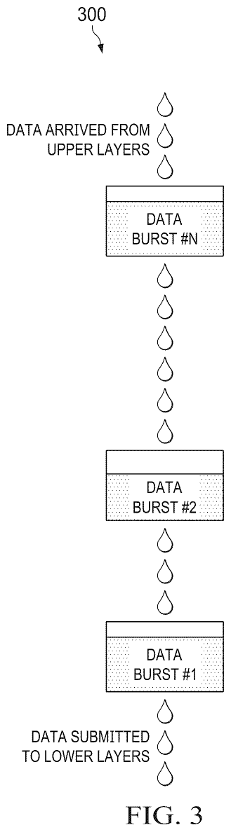

FIG. 3 illustrates an example of using Burst IDs currently being labelled (associated) with different data bursts buffered in a buffer 300 to determine transmission priorities among the different data bursts in accordance with an embodiment.

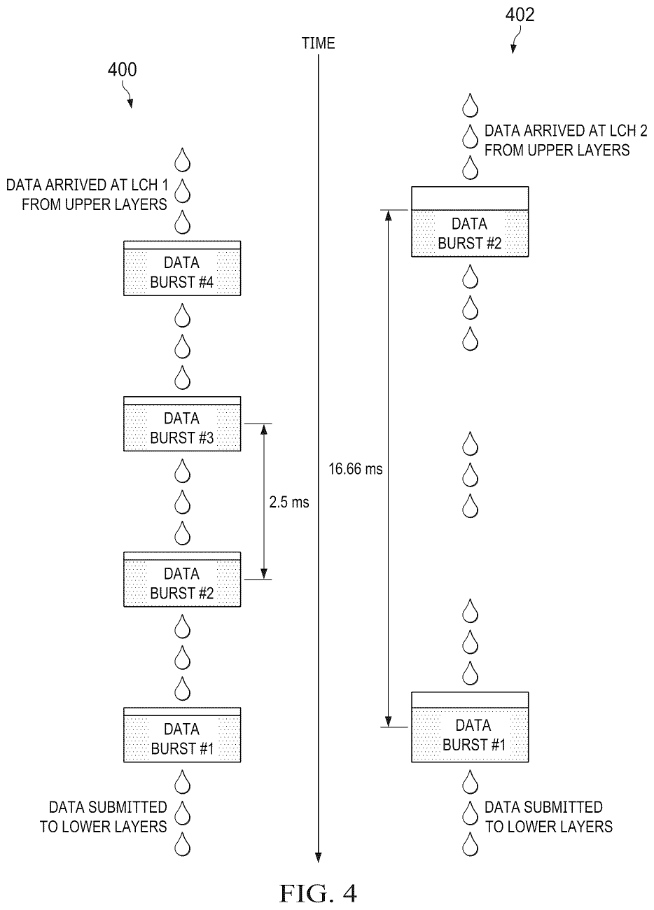

FIG. 4 is an example of two buffers 400, 402 configured in a UE for storing data in accordance with an embodiment. For the same situation illustrated in FIG. 2 (wherein data bursts from the pose/control stream and from the video stream arriving at two LCHs of the UE, respectively, with different periodicities and different PDBs), FIG. 4 illustrates an example of labelling data bursts stored in the buffer with different Burst ID values at different points in time, instead of moving the data bursts through cascaded sub-buffers (as in FIG. 2). The vertical space in between data bursts of a same LCH, as shown in FIG. 4, is to illustrate the temporal relationship between these data bursts. It does not imply that these data bursts are stored in or moved through different sub-buffers. In fact, data bursts arrived during consecutive traffic cycles at a same LCH can be contiguously stored in a same buffer 400, 402 of the LCH.

As shown in FIG. 4, when a first data burst newly arrives at LCH 1, the first data burst (or individual data packets among the first data burst) may be labeled with the Burst ID value of 4. And 2.5 msec later, the first data burst will be labeled with the Burst ID value of 3, while a second data burst newly arrived at LCH 1 will be labeled with the Burst ID value of 4, and so on and so forth. Meanwhile, when a third data burst newly arrives at LCH 2, the third data burst (or individual data packets among the third data burst) may be labeled with the Burst ID value of 2. And 16.666 msec later, the third data burst will be labeled with the Burst ID value of 1, while a fourth data burst newly arrived at LCH 2 will be labeled with the Burst ID value of 2. When the PDB or PSDB of a data burst has expired (i.e., when the delivery deadline of the data burst has passed) without completing the transmission of the data burst, the UE may discard any remaining packets of the data burst, e.g., by removing them from the buffer 400, 402, so that they are no longer being labelled (or associated) with any of the configured Burst ID values.

The gNB may further designate specific priority levels to each of the Burst ID values respectively configured for each LCH of the UE and provide the UE with information about designation of the priority levels. Using the example in FIG. 4, the gNB may send an RRC signaling message to provide the UE with information about the priority levels for each tuple of Burst ID value and LCH ID value, because in the example illustrated in FIG. 4, Burst IDs are only unique within LCH 1 and within LCH 2, but not between LCH 1 and LCH 2 (hence LCH ID is needed for unique identification). In this case, the UE may still keep tracking remaining time durations to the respective delivery deadlines of the different data bursts and use the remaining time durations to determine the transmission priorities of corresponding data bursts. Alternatively, the UE may simply use the priority levels that the gNB has designated for each tuple of Burst ID value and LCH ID value, the LCH ID of the LCH that the data bursts have respectively arrived at, and the Burst ID values currently being labelled (or associated) with the different data bursts to determine the transmission priorities of the data bursts.

In the various example embodiments described above, we have illustrated how the various inventive techniques can be used by a UE for prioritizing different data bursts arrived from upper layers for UL transmission. The same inventive techniques can also be used by a gNB for prioritizing different data bursts arrived from the network for DL transmission to one or more UEs served by the gNB.

For example, the gNB may receive information about the QoS requirements and QoS parameters for different QoS flows established for a UE or different UEs served by the gNB. Then, for each of the different QoS flows, based on the QoS requirements and QoS parameters of the QoS flow, the gNB determines to configure a plurality of cascaded leaky buckets (or sub-buffers) for buffering different data bursts arrived at an LCH configured for the QoS flow, for Embodiment 1, or to designate a plurality of burst IDs to be used for labeling the different data bursts arrived at the LCH configured for the QoS flow. The gNB may further designate a priority level to each of the plurality of leaky buckets (or sub-buffers) or to each of the burst IDs. The gNB may also keep tracking remaining time durations to the respective delivery deadlines of the different data bursts. The gNB may determine the transmission priorities among the different data bursts based on the priority levels of the leaky buckets currently buffering the different data bursts, respectively, or based on the priority levels associated with burst IDs currently being labeled with the different data bursts, respectively, or based on the remaining time durations to the respective delivery deadlines of the different data bursts. Then, the gNB may transmit the different data bursts based on information that includes at least the transmission priorities determined.

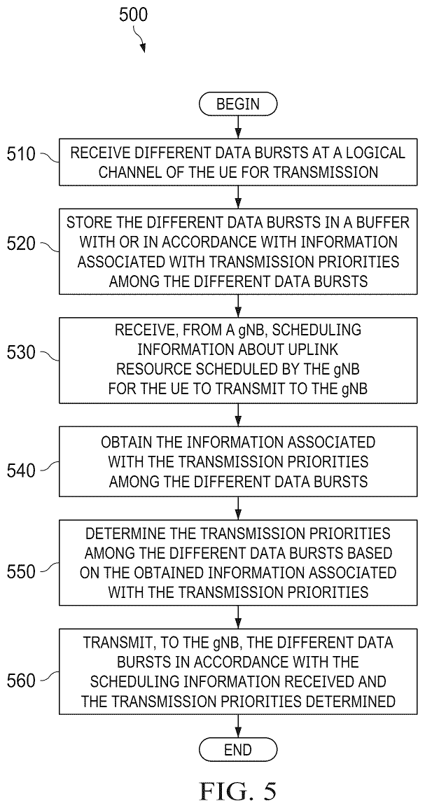

FIG. 5 illustrates a flow diagram of example embodiment of operations 500 occurring in a UE in accordance with an embodiment. Operations 500 may be indicative of operations occurring in a UE, as the UE reports its buffer status on an LCH, to a gNB serving the UE, on a per data burst basis and with information about remaining time until a delivery deadline being explicitly or implicitly indicated for the data being reported.

Operations 500 begin with the UE receiving different data bursts at a logical channel of the UE for transmission (step 510). For example, the different data bursts are received from upper layers at different points in time for transmission to a gNB serving the UE. For example, the different data bursts have different respective deadlines for delivery to the gNB. The UE stores the different data bursts in a buffer, either with or in accordance with information associated with transmission priorities among the different data bursts (step 520). In accordance with a first example embodiment, the information associated with the transmission priorities comprises information about the respective delivery deadlines of the different data bursts. The UE may track the remaining time durations until the respective delivery deadlines of the different data bursts while the different data bursts being stored in the buffer. In accordance with a second example embodiment, the information associated with the transmission priorities comprises information about the priorities assigned to different sub-buffers (also referred to as leaky buckets) currently buffering the different data bursts, respectively, wherein the information about the priorities assigned to the different sub-buffers have been received from the gNB. In accordance with a third example embodiment, the information associated with the transmission priorities comprises information about the priorities assigned to different burst IDs currently being associated with the different data bursts, respectively, wherein the information about the priorities assigned to the different burst IDs have been received from the gNB.

The UE receives, from the gNB, scheduling information about uplink resource scheduled by the gNB for the UE to transmit to the gNB (step 530). The UE obtains the information associated with the transmission priorities among the different data bursts (step 540).

In the first example embodiment where the information associated with the transmission priorities comprises information about the respective delivery deadlines of the different data bursts, obtaining the respective delivery deadlines of the different data bursts comprises determining, by the UE, arrival points in time of the different data bursts when the different data bursts respectively arrived at the logical channel of UE for transmission, and computing, by the UE, the respective delivery deadlines of the different data bursts as being equal to a sum of a delay budget and the respective arrival points in time of the different data bursts.

In the second example embodiment where the information associated with the transmission priorities comprises information about the priorities assigned to different sub-buffers (also referred to as leaky buckets) currently buffering the different data bursts, respectively, obtaining the information about the priorities comprises receiving, by the UE from the gNB, the information about the priorities assigned by the gNB to the different sub-buffers, and identifying, by the UE, the sub-buffers (also referred to as leaky buckets) currently buffering the different data bursts, respectively.

In the third example embodiment where the information associated with the transmission priorities comprises information about the priorities assigned by the gNB to different burst IDs currently being associated with the different data bursts, respectively, obtaining the information about the priorities comprises receiving, by the UE from the gNB, the information about the priorities assigned by the gNB to the different burst IDs, and identifying, by the UE, the burst IDs currently being associated with the different data bursts, respectively.

Then, the UE determines the transmission priorities among the different data bursts based on the obtained information associated with the transmission priorities (step 550). The UE transmits, to the gNB, the different data bursts in accordance with the scheduling information received and the transmission priorities determined (step 560). Then, operations 500 may end.

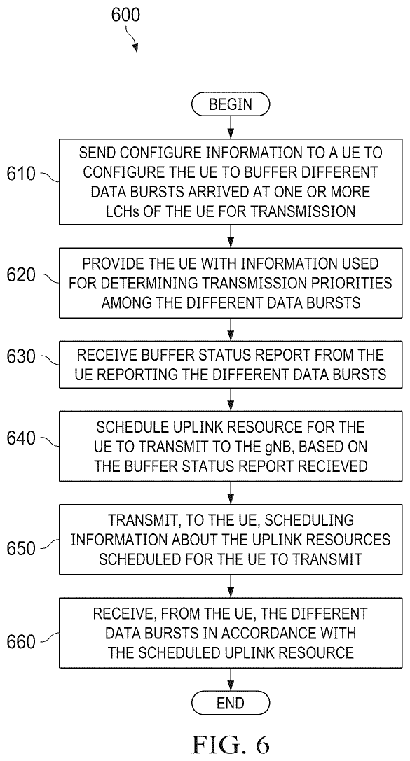

FIG. 6 illustrates a flow diagram of an example of operations 600 occurring in a RAN, such as a gNB, in accordance with an embodiment. Operations 600 may be indicative of operations occurring in a gNB, as the gNB configures a UE to prioritize the data bursts received from upper layers for transmission.

Operations 600 begin with the gNB sending configuration information to a UE served by the gNB to configure the UE to buffer different data bursts arrived at one or more LCHs of the UE for transmission to the gNB (step 610). The gNB also provides the UE with information used for determining transmission priorities among the different data bursts (step 620). The gNB receives a buffer status report from the UE reporting information about the different data bursts (step 630). The gNB schedules uplink resource for the UE to transmit to the gNB, based on the buffer status report received from the UE (step 640). Then, the gNB transmits, to the UE, scheduling information about the uplink resource scheduled for the UE to transmit to the gNB (step 650). For example, the gNB may transmit a DCI to the UE using the PDCCH, the DCI including the uplink scheduling information, and a cyclic redundancy check (CRC) carried on the PDCCH being scrambled with a radio network temporary identifier (RNTI) of the UE. The gNB receives, from the UE, the different data bursts in accordance with the scheduled uplink resource (step 660). Then, operations 600 may end.

Data buffering mechanism for the UE to buffer different data bursts received from upper layers for transmission while preserving information associated with transmission priorities among the different data bursts.

Prioritization mechanism for the UE to determine the transmission priorities among the different data bursts based on the information associated with the transmission priorities.

A signaling mechanism for the gNB to configure the UE to perform the buffering of different data bursts arrived at a logical channel of the UE for transmission and the prioritization among the different data bursts for the transmission.

Meeting stringent latency requirements of periodic and delay-sensitive traffic streams by prioritizing the transmission of different data bursts based on the remaining time durations to the respective delivery deadlines of the different data bursts.

Avoid unnecessary separation of packets of a data burst corresponding to a same application data unit (such as a video frame) during transmission of the data burst so that unnecessary delay can be avoided and there is a higher chance to maintain the integrity of the data burst at the application layer of a recipient.

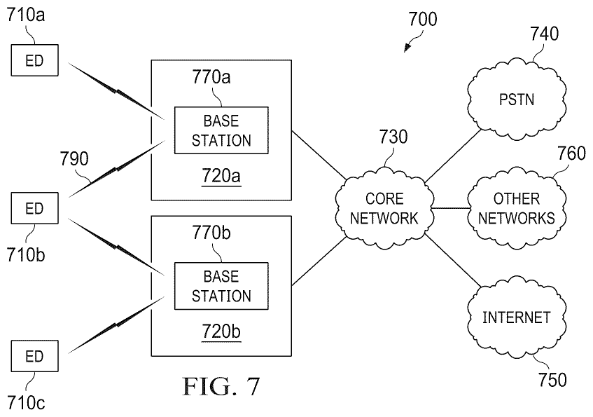

FIG. 7 illustrates an example communication system 700 in accordance with an embodiment. In general, the system 700 enables multiple wireless or wired users to transmit and receive data and other content. The system 700 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 700 includes electronic devices (ED) 710a-710c, radio access networks (RANs) 720a-720b, a core network 730, a public switched telephone network (PSTN) 740, the Internet 750, and other networks 760. While certain numbers of these components or elements are shown in FIG. 7, any number of these components or elements may be included in the system 700.

The EDs 710a-710c are configured to operate or communicate in the system 700. For example, the EDs 710a-710c are configured to transmit or receive via wireless or wired communication channels. Each ED 710a-710c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 720a-720b here include RAN nodes 770a-770b, respectively. RAN nodes 770a-770b may also be referred to as base stations 770a-770b, respectively. Each base station 770a-770b is configured to wirelessly interface with one or more of the EDs 710a-710c to enable access to the core network 730, the PSTN 740, the Internet 750, or the other networks 760. For example, the base stations 770a-770b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 710a-710c are configured to interface and communicate with the Internet 750 and may access the core network 730, the PSTN 740, or the other networks 760.

In the embodiment shown in FIG. 7, the base station 770a forms part of the RAN 720a, which may include other base stations, elements, or devices. Also, the base station 770b forms part of the RAN 720b, which may include other base stations, elements, or devices. Each base station 770a-770b operates to transmit or receive wireless signals within a particular geographic region or area, sometimes referred to as a “cell.” In some embodiments, multiple-input multiple-output (MIMO) technology may be employed having multiple transceivers for each cell.

The base stations 770a-770b communicate with one or more of the EDs 710a-710c over one or more air interfaces 790 using wireless communication links. The air interfaces 790 may utilize any suitable radio access technology.

It is contemplated that the system 700 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 720a-720b are in communication with the core network 730 to provide the EDs 710a-710c with voice, data, application, Voice over Internet Protocol (VoIP), or other services. Understandably, the RANs 720a-720b or the core network 730 may be in direct or indirect communication with one or more other RANs (not shown). The core network 730 may also serve as a gateway access for other networks (such as the PSTN 740, the Internet 750, and the other networks 760). In addition, some or all of the EDs 710a-710c may include functionality for communicating with different wireless networks over different wireless links using different wireless technologies or protocols. Instead of wireless communication (or in addition thereto), the EDs may communicate via wired communication channels to a service provider or switch (not shown), and to the Internet 750.

Although FIG. 7 illustrates one example of a communication system, various changes may be made to FIG. 7. For example, the communication system 700 could include any number of EDs, base stations, networks, or other components in any suitable configuration.

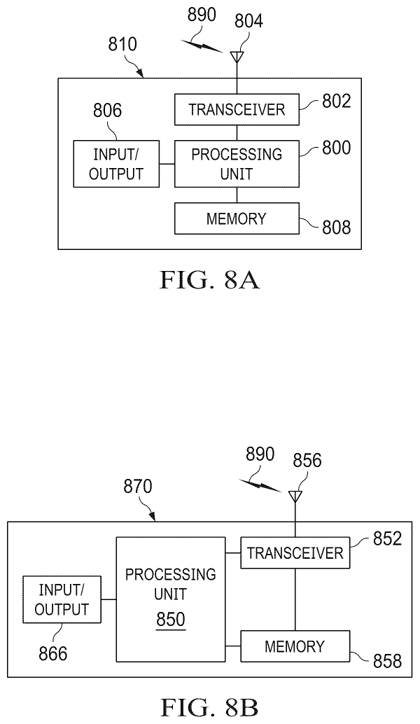

FIGS. 8A and 8B illustrate example devices that may implement the methods and teachings according to this disclosure. In particular, FIG. 8A illustrates an example ED 810, and FIG. 8B illustrates an example base station 870. These components could be used in the system 700 or in any other suitable system.

As shown in FIG. 8A, the ED 810 includes at least one processing unit 800. The processing unit 800 implements various processing operations of the ED 810. For example, the processing unit 800 could perform signal coding, data processing, power control, input/output processing, or any other functionality enabling the ED 810 to operate in the system 700. The processing unit 800 also supports the methods and teachings described in more detail above. Each processing unit 800 includes any suitable processing or computing device configured to perform one or more operations. Each processing unit 800 could, for example, include a microprocessor, microcontroller, digital signal processor, field programmable gate array, or application specific integrated circuit.

The ED 810 also includes at least one transceiver 802. The transceiver 802 is configured to modulate data or other content for transmission by at least one antenna 804. The transceiver 802 is also configured to demodulate data or other content received by the at least one antenna 804. Each transceiver 802 includes any suitable structure for generating signals for wireless or wired transmission or processing signals received wirelessly or by wire. Each antenna 804 includes any suitable structure for transmitting or receiving wireless or wired signals. One or multiple transceivers 802 could be used in the ED 810, and one or multiple antennas 804 could be used in the ED 810. Although shown as a single functional unit, a transceiver 802 could also be implemented using at least one transmitter and at least one separate receiver.

The ED 810 further includes one or more input/output devices 806 or interfaces (such as a wired interface to the Internet 750). The input/output devices 806 facilitate interaction with a user or other devices (network communications) in the network. Each input/output device 806 includes any suitable structure for providing information to or receiving information from a user, such as a speaker, microphone, keypad, keyboard, display, or touch screen, including network interface communications.

In addition, the ED 810 includes at least one memory 808. The memory 808 stores instructions and data used, generated, or collected by the ED 810. For example, the memory 808 could store software or firmware instructions executed by the processing unit(s) 800 and data used to reduce or eliminate interference in incoming signals. Each memory 808 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 8B, the base station 870 includes at least one processing unit 850, at least one transceiver 852, which includes functionality for a transmitter and a receiver, one or more antennas 856, at least one memory 858, and one or more input/output devices or interfaces 866. A scheduler, which would be understood by one skilled in the art, is coupled to the processing unit 850. The scheduler could be included within or operated separately from the base station 870. The processing unit 850 implements various processing operations of the base station 870, such as signal coding, data processing, power control, input/output processing, or any other functionality. The processing unit 850 can also support the methods and teachings described in more detail above. Each processing unit 850 includes any suitable processing or computing device configured to perform one or more operations. Each processing unit 850 could, for example, include a microprocessor, microcontroller, digital signal processor, field programmable gate array, or application specific integrated circuit.

Each transceiver 852 includes any suitable structure for generating signals for wireless or wired transmission to one or more EDs or other devices. Each transceiver 852 further includes any suitable structure for processing signals received wirelessly or by wire from one or more EDs or other devices. Although shown combined as a transceiver 852, a transmitter and a receiver could be separate components. Each antenna 856 includes any suitable structure for transmitting or receiving wireless or wired signals. While a common antenna 856 is shown here as being coupled to the transceiver 852, one or more antennas 856 could be coupled to the transceiver(s) 852, allowing separate antennas 856 to be coupled to the transmitter and the receiver if equipped as separate components. Each memory 858 includes any suitable volatile or non-volatile storage and retrieval device(s). Each input/output device 866 facilitates interaction with a user or other devices (network communications) in the network. Each input/output device 866 includes any suitable structure for providing information to or receiving/providing information from a user, including network interface communications.

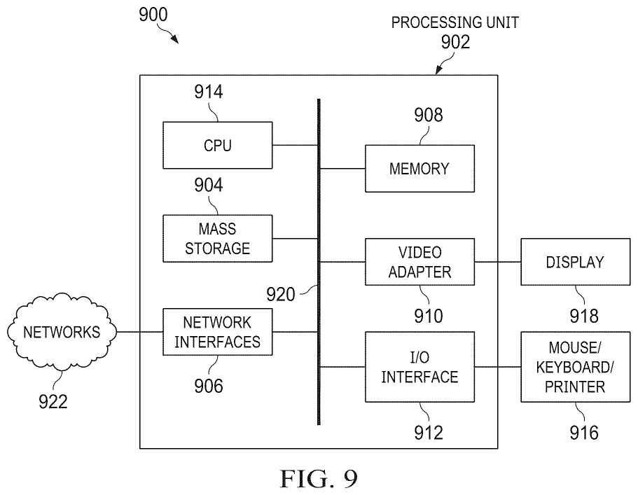

FIG. 9 is a block diagram of a computing system 900 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 900 includes a processing unit 902. The processing unit includes a central processing unit (CPU) 914, memory 908, and may further include a mass storage device 904, a video adapter 910, and an I/O interface 912 connected to a bus 920.

The bus 920 may be one or more of any type of several bus architectures including a memory bus or memory controller, a peripheral bus, or a video bus. The CPU 914 may comprise any type of electronic data processor. The memory 908 may comprise any type of non-transitory system memory such as static random access memory (SRAM), dynamic random access memory (DRAM), synchronous DRAM (SDRAM), read-only memory (ROM), or a combination thereof. In an embodiment, the memory 908 may include ROM for use at boot-up, and DRAM for program and data storage for use while executing programs. The memory 908 may include LCH buffers such as those illustrated in FIGS. 1-4.

The mass storage 904 may comprise any type of non-transitory storage device configured to store data, programs, and other information and to make the data, programs, and other information accessible via the bus 920. The mass storage 904 may comprise, for example, one or more of a solid state drive, hard disk drive, a magnetic disk drive, or an optical disk drive.

The video adapter 910 and the I/O interface 912 provide interfaces to couple external input and output devices to the processing unit 902. As illustrated, examples of input and output devices include a display 918 coupled to the video adapter 910 and a mouse, keyboard, or printer 916 coupled to the I/O interface 912. Other devices may be coupled to the processing unit 902, and additional or fewer interface cards may be utilized. For example, a serial interface such as Universal Serial Bus (USB) (not shown) may be used to provide an interface for an external device.

The processing unit 902 also includes one or more network interfaces 906, which may comprise wired links, such as an Ethernet cable, or wireless links to access nodes or different networks. The network interfaces 906 allow the processing unit 902 to communicate with remote units via the networks. For example, the network interfaces 906 may provide wireless communication via one or more transmitters/transmit antennas and one or more receivers/receive antennas. In an embodiment, the processing unit 902 is coupled to a local-area network 922 or a wide-area network for data processing and communications with remote devices, such as other processing units, the Internet, or remote storage facilities.

In an embodiment, the network interface 906 may include a transceiver that may transmit and receive signaling over any type of communications medium. In some embodiments, the transceiver transmits and receives signaling over a wireless medium. For example, the transceiver may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network interface 906 may include one or more antenna/radiating elements. For example, the network interface 906 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

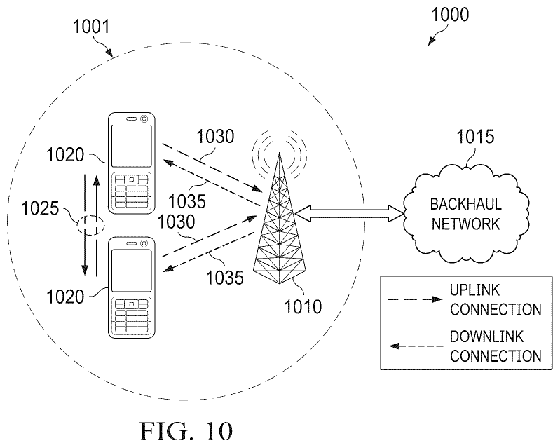

FIG. 10 illustrates an example communications system 1000. Communications system 1000 includes an access node 1010 serving user equipments (UEs) with coverage area 1001, such as UEs 1020. In a first operating mode, communications to and from a UE passes through access node 1010 with coverage area 1001. The access node 1010 is connected to a backhaul network 1015 for connecting to the internet, operations and management, and so forth. In a second operating mode, communications to and from a UE do not pass through access node 1010, however, access node 1010 typically allocates resources used by the UE to communicate when specific conditions are met. Communications between a pair of UEs 1020 can use a sidelink connection (shown as two separate one-way connections 1025). In FIG. 10, the sidelink communication is occurring between two UEs operating inside of coverage area 1001. However, sidelink communications, in general, can occur when UEs 1020 are both outside coverage area 1001, both inside coverage area 1001, or one inside and the other outside coverage area 1001. Communication between a UE and access node pair occurs over uni-directional communication links, where the communication links between the UE and the access node are referred to as uplinks 1030, and the communication links between the access node and UE is referred to as downlinks 1035.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of this disclosure.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by an information obtaining unit/module, a storage unit/module, a priority determining unit/module, a scheduling unit/module, and/or a buffering unit/module. The respective units/modules may be hardware, software, or a combination thereof. For instance, one or more of the units/modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method implemented by a user equipment (UE), the method comprising:
receiving a first data burst and a second data burst at one or more logical channels of the UE for transmission to a radio access network (RAN) node serving the UE, the first data burst and the second data burst having different deadlines for delivery;
obtaining information associated with transmission priorities for the first data burst and the second data burst;
storing the first data burst and the second data burst in a buffer in accordance with the information associated with the transmission priorities for the first data burst and the second data burst;
receiving, from the RAN node, scheduling information about an uplink resource scheduled by the RAN node for the UE to transmit to the RAN node;
determining the transmission priorities between the first data burst and the second data burst based on the information associated with the transmission priorities; and
transmitting, to the RAN node, uplink data from at least one of at least a portion of the first data burst and at least a portion of the second data burst in accordance with the scheduling information and the transmission priorities.

2. The method of claim 1, wherein the information associated with the transmission priorities includes at least one of a remaining time until a respective delivery deadline for each of the first data burst and the second data burst, priorities assigned to each of a plurality of sub-buffers used for storing the first data burst and the second data burst, priorities assigned to labels associated with the first data burst and the second data burst that indicate a sequences of respective deadlines for delivery associated with the each of the first data burst and the second data burst, a respective dwelling time of the each of the first data burst and the second data burst at the UE, an indication of or a lack of the indication of end Protocol Data Unit (PDU) of a PDU set associated with a respective one of the first data burst and the second data burst, an indication of or a lack of the indication of end of data burst associated with a respective one of the first data burst and the second data burst, a PDU set integrity handling information associated with a respective one of the first data burst and the second data burst, or a PDU set importance associated with a respective one of the first data burst and the second data burst.

3. The method of claim 1, wherein the information associated with the transmission priorities comprises information about respective delivery deadlines of the first data burst and the second data burst, and wherein the obtaining the information associated with the transmission priorities comprises:
determining, by the UE, arrival points in time of the first data burst and the second data burst when the first data burst and the second data burst respectively arrived at the one or more logical channels of the UE for transmission; and
determining, by the UE, the respective delivery deadlines of the first data burst and the second data burst as being equal to a sum of a delay budget and respective arrival points in time of the first data burst and the second data burst.

4. The method of claim 1, further comprising:
receiving information about a delay budget from a session management function (SMF) serving the UE.

5. The method of claim 1, wherein the information associated with the transmission priorities comprises information about priorities assigned to different sub-buffers of the buffer currently buffering the first data burst and the second data burst, respectively, and wherein the obtaining the information associated with the transmission priorities comprises:
receiving, by the UE from the RAN node, the information about priorities assigned by the RAN node to the different sub-buffers; and
identifying, by the UE, sub-buffers currently buffering the first data burst and the second data burst, respectively.

6. The method of claim 5, further comprising:
determining that one traffic period has ended, and based thereon, transferring each of the first data burst and the second data burst from a current sub-buffer of the buffer to a next sub-buffer of the buffer, the next sub-buffer being located immediately below the current sub-buffer and being logically connected to the current sub-buffer, the buffer including a plurality of cascaded sub-buffers.

7. The method of claim 1, wherein the information associated with the transmission priorities comprises information about priorities assigned by the RAN node to different values for a burst identifier (ID) and burst ID values currently being associated with different data bursts, respectively, and wherein the obtaining the information associated with the transmission priorities comprises:
receiving, by the UE from the RAN node, the information about the transmission priorities assigned by the RAN node to the different values for the burst ID, and identifying, by the UE, the burst ID values currently being associated with the first data burst and the second data burst, respectively.

8. The method of claim 7, further comprising:
associating each of the first data burst and the second data burst with a respective burst ID at a time when the each of the first data burst and the second data burst arrived at the one or more logical channels of the UE, a value of the respective burst ID being initially set to a specific value configured by the RAN node for the one or more logical channels; and
at every time instance when a new traffic period has elapsed, decrementing the burst ID values currently being associated with the different data bursts by one.

9. The method of claim 1, further comprising:
transmitting, by the UE, information indicating UE capabilities of prioritizing the uplink data to the RAN node; and
receiving, at the UE, configuration information from the RAN node, wherein the configuration information provides information for the UE to perform prioritization of the first data burst and the second data burst.

10. The method of claim 1, wherein the RAN node comprises a Next Generation (NG) NodeB (gNB).

11. An apparatus comprising:
a non-transitory memory storage storing instructions; and
one or more processors in communication with the non-transitory memory storage, the one or more processors executing the instructions to cause the apparatus to perform operations including:
receiving a first data burst and a second data burst at one or more logical channels of the apparatus for transmission to a radio access network (RAN) node serving the apparatus, the first data burst and the second data burst having different deadlines for delivery;
obtaining information associated with transmission priorities for the first data burst and the second data burst;
storing the first data burst and the second data burst in a buffer in accordance with the information associated with the transmission priorities for the first data burst and the second data burst;
receiving, from the RAN node, scheduling information about an uplink resource scheduled by the RAN node for the apparatus to transmit to the RAN node;
determining the transmission priorities between the first data burst and the second data burst based on the information associated with the transmission priorities; and
transmitting, to the RAN node, uplink data from at least one of at least a portion of the first data burst and at least a portion of the second data burst in accordance with the scheduling information and the transmission priorities.

12. A method implemented by a radio access network (RAN) node, the method comprising:
sending configuration information to a user equipment (UE) to configure the UE to buffer different data bursts arrived at one or more logical channels of the UE for transmission, the UE being served by the RAN node;
providing the UE with information used for determining transmission priorities among the different data bursts;
transmitting, to the UE, scheduling information about an uplink resource scheduled for the UE to transmit to the RAN node; and
receiving, from the UE, the different data bursts in accordance with the uplink resource.

13. The method of claim 12, further comprising:
receiving a report from the UE, the report including information about the different data bursts being buffered at the UE for transmission to the RAN node; and
scheduling the uplink resource for the UE to transmit to the RAN node based on the report received.

14. The method of claim 12, wherein information used for determining transmission priorities among the different data bursts includes at least one of a remaining time until a respective delivery deadline for each of the different data bursts, priorities assigned to each of a plurality of sub-buffers used for storing the different data bursts, priorities assigned to labels associated with the different data bursts that indicate a sequences of respective deadlines for delivery associated with the each of the different data bursts, a respective dwelling time of each of the different data bursts at the UE, an indication of or a lack of the indication of end Protocol Data Unit (PDU) of a PDU set associated with a respective one of the different data bursts, an indication of or a lack of the indication of end of data burst associated with a respective one of the different data bursts, a PDU set integrity handling information associated with a respective one of the different data bursts, or a PDU set importance associated with a respective one of the different data bursts.

15. The method of claim 12, the configuration information including information of a specific number of cascaded sub-buffers to be configured in a buffer of the UE and to be used by the UE for buffering the different data bursts, respectively.

16. The method of claim 15, the information provided to the UE for determining the transmission priorities among the different data bursts including information about the transmission priorities respectively assigned by the RAN node to the specific number of cascaded sub-buffers.

17. The method of claim 12, the configuration information including information of a specific number used for initializing a value of a burst identifier (ID) that is associated with each of the different data bursts at a time when the each of the different data bursts arrived at a logical channel of the UE for transmission.

18. The method of claim 17, the information provided to the UE for determining the transmission priorities among the different data bursts including information about the transmission priorities respectively assigned by the RAN node to a specific number of different values for the burst ID.

19. The method of claim 18, further comprising:
receiving information about quality of service (QoS) requirements of a service of the UE, the different data bursts being generated for the service, the specific number being determined based on the information about the QoS requirements.

20. The method of claim 12, further comprising:
receiving, from the UE, information indicating UE capabilities of prioritizing uplink data;
determining the configuration information to be sent to the UE according to the UE capabilities of prioritizing uplink data; and
transmitting the configuration information to the UE.
